(19) United States
(12) Patent Application Publication
(10) Pub. No.: US 2012/0285783 A1
(43) Pub. Date: Nov. 15, 2012

(54) One-way cluth

(76) Inventor: Carlos Raul Espinosa-Montalvo, Quito (EC)

(21) Appl. No.: 13/067,097

(22) Filed: May 9, 2011

(51) Int. Cl. F16D 41/06

(52) U.S. Cl. 192/45.1

(57) ABSTRACT

A one-way clutch includes an inner ring, an outer ring, a chamber between the inner ring and the outer ring; the outer ring includes a plurality of radially inwardly extending teeth facing the chamber; each of the outer ring teeth having a first path and a second path producing an alternating crest and valley formation; the first path having a greater length than the second path; the inner ring defines a plurality of radially outwardly extending teeth facing and contacting the outer ring teeth in the chamber; the inner ring teeth are configured and positioned within the inner ring thereof, at any rotational movement of the inner ring and the outer ring, at least one of the inner ring teeth is frictionally engaged with the second path; each of the inner ring teeth having a tooth support system in the inner ring; each of the inner ring teeth is radially movable within the tooth support system; the inner ring and the outer ring having a relative rotational movement when at least one of the inner ring teeth having a radially outwardly movement within the tooth support system contacting the second path; and wherein the inner ring and the outer ring having a interlocking feature when at least one of the inner ring teeth having a frictional engagement contacting the second path and preventing a radially inwardly movement within the tooth support system.

### BACKGROUND OF THE INVENTION

This invention relates to one-way clutches.

One-way clutches transmit movement in one direction but do not in the opposite direction.

One-way clutches have a backlash movement. Some applications require a reduced backlash.

Thus, there is a need for a one-way clutch having a reduced backlash.

Accordingly, besides the objects and advantages of the one-way clutch described in my above patent, several objects and advantages of the present invention are:
(a) to provide a one-way clutch and can be used with a variety of applications; and
(b) to provide a one-way clutch with a reduced backlash.

Still further objects and advantages will become apparent form a consideration of the ensuing description and drawing.

### BRIEF SUMMARY OF THE INVENTION

A one-way clutch is provided. The one-way clutch includes: an inner ring; an outer ring is disposed concentrically about the inner ring; a chamber between the inner ring and the outer ring; the outer ring having a plurality of radially inwardly extending teeth facing the chamber; each of the outer ring teeth is uniformly angularly distributed around a circumference of the outer ring; each of the outer ring teeth having a first path and a second path producing an alternating crest and valley formation; the first path having a greater length than the second path; the inner ring defines a plurality of radially outwardly extending teeth facing and contacting the outer ring teeth in the chamber; each of the inner ring teeth is spaced around a circumference of the inner ring; the inner ring teeth are configured and positioned within the inner ring thereof, at any rotational movement of the inner ring and the outer ring, at least one of the inner ring teeth is frictionally engaged with the second path; each of the inner ring teeth having a tooth support system in the inner ring; each of the inner ring teeth is radially movable within the tooth support system; the inner ring and the outer ring having a relative rotational movement when at least one of the inner ring teeth having a radially outwardly movement within the tooth support system contacting the second path; and wherein the inner ring and the outer ring having a interlocking feature when at least one of the inner ring teeth having a frictional engagement contacting the second path and preventing a radially inwardly movement within the tooth support system.

These and other features and advantages of the invention will become apparent to those skilled in the art upon review of the following drawing, the detailed description, and the appended claims.

### BRIEF DESCRIPTION OF THE DRAWING

FIG. 1 is a-view of a one-way clutch according to the embodiments of the present invention.

### DETAILED DESCRIPTION OF THE INVENTION

The following description is merely exemplary in nature and is not intended to limit the present disclosure, application, or uses.

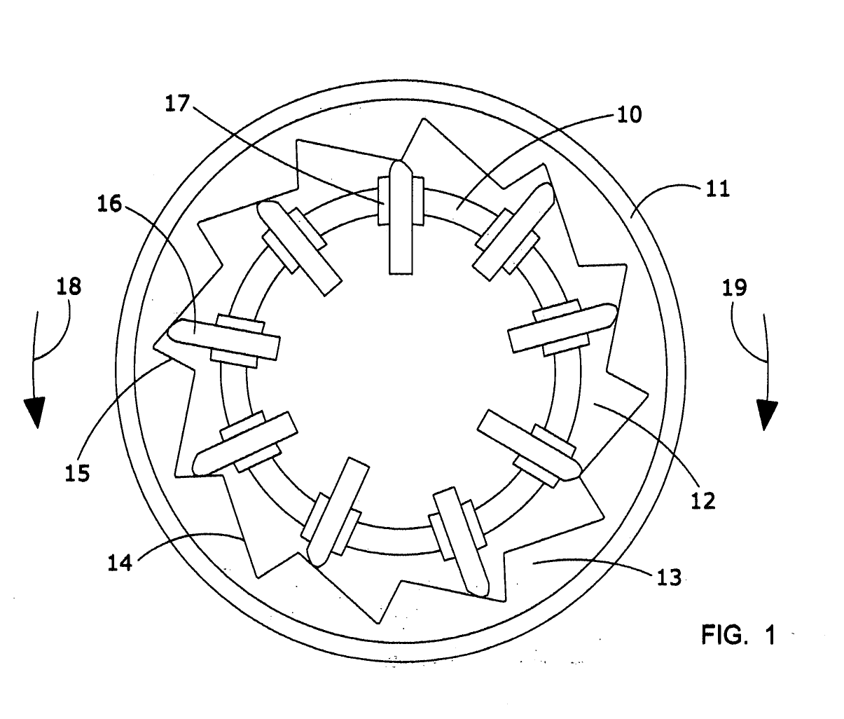

FIG. 1 is a view showing an inner ring 10 and an outer ring 11 which are concentric and arranged for rotational movement. A chamber 12 is defined between the rings 10 and 11. The outer ring 11 has a plurality of radially inwardly extending teeth 13 facing the chamber 12. The ring teeth 13 are uniformly angularly distributed around the outer ring 11; each one of the ring teeth 13 includes a first path 14 and a second path 15; the length of the first path 14 is greater than the length of the second path 15; the inner ring 10 has a plurality of radially outwardly extending teeth 16 facing and contacting the outer ring teeth 13 in the chamber 12; each of the inner ring teeth 16 is spaced around the inner ring 10; the inner ring teeth 16 are configured and positioned in the inner ring 10 thereof, at any rotational movement of the inner ring 10 and the outer ring 11, at least one of the inner ring teeth 16 is frictionally engaged with the second path 15; each of the inner ring teeth 16 is positioned in a tooth support system 17 within the inner ring 10; each of the inner ring teeth 16 is radially movable within the tooth support system 17.

The inner ring 10 and the outer ring 11 have a relative rotational movement when at least one of the inner ring teeth 16 has a radially outwardly movement within the tooth support system 17 by tooth contact in the second path 15. The relative rotational movement is achieved when the outer ring 11 has a rotational movement 18 or is stationary, and the inner ring 10 is stationary or has a rotational movement 19, respectively.

The inner ring 10 and the outer ring 11 have a interlocking feature when at least one of the inner ring teeth 16 has a frictional engagement contacting the second path 15 and preventing a radially inwardly movement within the tooth support system 17. The interlocking feature is achieved when the outer ring 11 has the rotational movement 19 and the inner ring 10 is being driven by the outer ring 11, or when the inner ring 10 has the rotational movement 18 and the outer ring 11 is being driven by the inner ring 10.

Accordingly, the reader will see that the one-way clutch of this invention can be used with several types of applications, such as, for example, transmissions of a fixed ratio, or transmissions of multiple stepped ratios, or transmissions of continuously or infinitely variable ratios.

The present invention achieves the use of radially movable teeth in the inner ring of the one-way clutch. A modification can be the use of radially movable teeth in an outer ring of a one-way clutch. A variation can be the use of axially movable teeth in a one-way clutch.

As used in this specification and claims, the terms “for example,” “for instance,” and “such as,” and the verbs “comprising;” “having,” “including,” and their other verb forms, when used in conjunction with a listing of one or more components or other items, are each to be construed as open-ended, meaning that the listing is not to be considered as excluding other, additional components, elements, or items. Moreover, directional words such as top, bottom, upper, lower, radial, circumferential, axial, lateral, longitudinal, vertical, horizontal, and the like are employed by way of description and not limitation. Other terms are to be construed using their broadest reasonable meaning unless they are used in a context that requires a different interpretation. When introducing elements of the present invention or the forms thereof, the articles “a,” “an,” “the,” and “said” are intended to mean that there are one or more of the elements.

It is to be understood that the foregoing description is not a description of the invention, but is a description of one or more presently preferred forms of the invention. Accordingly, the invention is not limited to the particular exemplary forms disclosed herein, but rather is defined solely by the claims below. In other words, the statements contained in the foregoing description relate to particular exemplary forms and are not to be construed as limitations on the scope of the invention as claimed below or on the definition of terms used in the claims, except where a term or phrase is expressly defined above or where the statement specifically refers to “the invention.”

Although the present invention has been disclosed in conjunction with a limited number of presently preferred exemplary forms, many others are possible and it is not intended herein to mention all of the possible equivalent forms and ramifications of the present invention. Other modifications, variations, forms, ramifications, substitutions, and/or equivalents will become apparent or readily suggest themselves to persons of ordinary skill in the art in view of the foregoing description. In other words, the teachings of the present invention encompass many reasonable substitutions or equivalents of limitations recited in the following claims. As just one example, the disclosed structure, materials, sizes, shapes, and the like could be readily modified or substituted with other similar structure, materials, sizes, shapes, and the like. Indeed, the present invention is intended to embrace all such forms, ramifications, modifications, variations, substitutions, and/or equivalents as fall within the spirit and broad scope of the following claims.

What is claimed is:

1. A one-way clutch comprising: an inner ring; an outer ring is disposed concentrically about said inner ring; a chamber between said inner ring and said outer ring; said outer ring defines a plurality of radially inwardly extending teeth facing said chamber, each of said outer ring teeth is uniformly angularly distributed around a circumference of said outer ring; each of said outer ring teeth having a first path and a second path producing an alternating crest and valley formation; said first path having a greater length than said second path; said inner ring defines a plurality of radially outwardly extending teeth facing and contacting said outer ring teeth in said chamber; each of said inner ring teeth is spaced around a circumference of said inner ring; said inner ring teeth are configured and positioned within said inner ring thereof, at any rotational movement of said inner ring and said outer ring, at least one of said inner ring teeth is frictionally engaged with said second path; each of said inner ring teeth having a tooth support system in said inner ring; each of said inner ring teeth is radially movable within said tooth support system; said inner ring and said outer ring having a relative rotational movement when at least one of said inner ring teeth having a radially outwardly movement within said tooth support system contacting said second path; and wherein said inner ring and said outer ring having a interlocking feature when at least one of said inner ring teeth having a frictional engagement contacting said second path and preventing a radially inwardly movement within said tooth support system.

2. The one-way clutch of claim 1 wherein said first path has a coefficient of friction that is lower than that of said second path.

3. The one-way clutch of claim 1 wherein each of said tooth support systems further comprises a spring means for contacting said inner ring teeth and said outer ring teeth.
